(19) United States
(12) Patent Application Publication
(10) Pub. No.: US 2023/0042275 A1
(43) Pub. Date: Feb. 9, 2023

(54) NETWORK QUANTIZATION METHOD AND NETWORK QUANTIZATION DEVICE

(71) Applicant: Socionext Inc., Kanagawa (JP)

(72) Inventor: Yukihiro SASAGAWA, Yokohama (JP)

(21) Appl. No.: 17/966,396

(22) Filed: Oct. 14, 2022

Related U.S. Application Data
(63) Continuation of application No. PCT/JP2021/015786, filed on Apr. 16, 2021.

(30) Foreign Application Priority Data
May 13, 2020 (JP) 2020-084712

(51) Int. Cl. G06N 3/04; G06K 9/62

(52) U.S. Cl. CPC G06N 3/04; G06K 9/6227; G06K 9/6298

(57) ABSTRACT

A network quantization method is a network quantization method of quantizing a neural network, and includes a database construction step of constructing a statistical information database on tensors that are handled by neural network, a parameter generation step of generating quantized parameter sets by quantizing values included in each tensor in accordance with the statistical information database and the neural network, and a network construction step of constructing a quantized network by quantizing the neural network with use of the quantized parameter sets. The parameter generation step includes a quantization-type determination step of determining a quantization type for each of a plurality of layers that make up the neural network.

### CROSS REFERENCE TO RELATED APPLICATIONS

This is a continuation application of PCT International Application No. PCT/JP2021/015786 filed on Apr. 16, 2021, designating the United States of America, which is based on and claims priority of Japanese Patent Application No. 2020-084712 filed on May 13, 2020. The entire disclosures of the above-identified applications, including the specifications, drawings and claims are incorporated herein by reference in their entirety.

### FIELD

The present disclosure relates to a network quantization method and a network quantization device.

### BACKGROUND

Machine learning is performed conventionally using a network such as a neural network. The term network as used herein refers to a model that inputs numeric data and obtains output values of the numeric data through computations of some kind. In the case where a network is implemented in hardware such as a computer, it will be desired to construct a network having low computational accuracy in order to keep hardware costs down while maintaining inference accuracy after the implementation at approximately the same level as floating-point accuracy.

For example, hardware costs will increase in the case of implementing a network that performs all calculations with floating-point accuracy. There is thus demand for realization of a network that performs calculations with fixed-point accuracy while maintaining the inference accuracy unchanged.

Hereinafter, a network having floating-point accuracy may also be referred to as a pre-quantization network, and a network having fixed-point accuracy may also be referred to as a quantized network. The term quantization as used herein refers to processing for dividing floating-point values that can continuously represent roughly arbitrary values into predetermined ranges to encode the values. More generally, the term quantization is defined as processing for reducing the range or number of digits of numerical values that are handled by a network.

In the case where a real number is expressed by the number of bits limited by quantization, the distribution of input data may become different from an assumed distribution. In this case, there is a problem in that quantization errors may become larger and cause adverse effects on the speed of machine learning and further on the inference accuracy after learning.

As a method for addressing this problem, for example, a method disclosed in Patent Literature (PTL) 1 is known. The method described in PTL 1 defines an individual fixed-point format for weight and each data in each layer of a convolutional neural network. Machine learning of the convolutional neural network is started with floating point numbers, and analysis is conducted to infer the distribution of input data. Then, an optimized number format that represents input data values is determined in accordance with the distribution of input data, and quantization is performed using this format. In this way, PTL 1 tries to solve the problem described above by first consulting the distribution of input data and then selecting a number format suitable for the distribution.

### CITATION LIST

### Patent Literature

PTL 1: Japanese Unexamined Patent Application Publication No. 2018-10618

### SUMMARY

### Technical Problem

In the method described in PTL 1, a dynamic range of data to be handled is taken into consideration, and a limited number of bits is assigned to a range in which the data falls. In this case, effective use of the number of bits may not be possible depending on the characteristics of the data. For example, the ratio of meaningful data value to the number of bits may become small. In this way, bit assignment may become inefficient.

In view of this, the present disclosure has been made in order to solve problems as described above, and it is an object of the present disclosure to provide a network quantization method and so on capable of constructing a quantized network in which bits are assigned efficiently.

### Solution to Problem

To achieve the object described above, a network quantization method according to one embodiment of the present disclosure is a network quantization method of quantizing a neural network. The network quantization method includes preparing the neural network, constructing a statistical information database on a tensor that is handled by the neural network, the tensor being obtained by inputting a plurality of test data sets to the neural network, generating a quantized parameter set by quantizing a value included in the tensor in accordance with the statistical information database and the neural network, and constructing a quantized network by quantizing the neural network with use of the quantized parameter set. The generating includes determining a quantization type for each of a plurality of layers that make up the neural network.

To achieve the object described above, a network quantization device according to one embodiment of the present disclosure is a network quantization device for quantizing a neural network. The network quantization device includes a database constructor that constructs a statistical information database on a tensor that is handled by the neural network, the tensor being obtained by inputting a plurality of test data sets to the neural network, a parameter generator that generates a quantized parameter set by quantizing a value included in the tensor in accordance with the statistical information database and the neural network, and a network constructor that constructs a quantized network by quantizing the neural network with use of the quantized parameter set. The parameter generator determines a quantization type for each of a plurality of layers that make up the neural network.

### Advantageous Effects

According to the present disclosure, it is possible to provide a network quantization method and so on capable of constructing a quantized network in which bits are assigned efficiently.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating an overview of a functional configuration of a network quantization device according to Embodiment 1.

FIG. 2 is a diagram showing one example of a hardware configuration of a computer for implementing, via software, functions of the network quantization device according to Embodiment 1.

FIG. 3 is a flowchart illustrating a procedure of a network quantization method according to Embodiment 1.

FIG. 4 is a flowchart illustrating a procedure of a method of generating quantized parameter sets according to Embodiment 1.

FIG. 5 is an illustration of a table showing one example of the relationship between redundancies and suitable quantization types according to Embodiment 1.

FIG. 6 is a graph for describing ternary transformation of numerical values with floating-point accuracy.

FIG. 7 is a block diagram illustrating an overview of a functional configuration of a network quantization device according to Embodiment 2.

FIG. 8 is a flowchart illustrating a procedure of a network quantization method according to Embodiment 2.

FIG. 9 is a flowchart illustrating a procedure of a parameter generation step according to Embodiment 2.

FIG. 10 is a flowchart illustrating a procedure of a quantization-type determination step according to Embodiment 2.

FIG. 11 is a graph for describing pseudo-ternary transformation of numerical values with floating-point accuracy.

### DESCRIPTION OF EMBODIMENTS

Hereinafter, embodiments of the present disclosure will be described in detail with reference to the drawings. It is to be noted that each embodiment described below is one specific example of the present disclosure. Numerical values, shapes, materials, specifications, constituent elements, arrangement and connection of constituent elements, steps, a sequence of steps, and so on given in the following embodiments are mere examples and do not intend to limit the scope of the present disclosure. Among the constituent elements described in the following embodiments, those that are not recited in any of the independent claims, which define the most generic concept of the present disclosure, are described as arbitrary constituent elements. Each drawing does not always provide precise depiction. In the drawings, configurations that are substantially the same may be given the same reference signs, and redundant description thereof may be omitted or simplified.

### Embodiment 1

A network quantization method and a network quantization device according to Embodiment 1 will be described.

### 1-1. Network Quantization Device

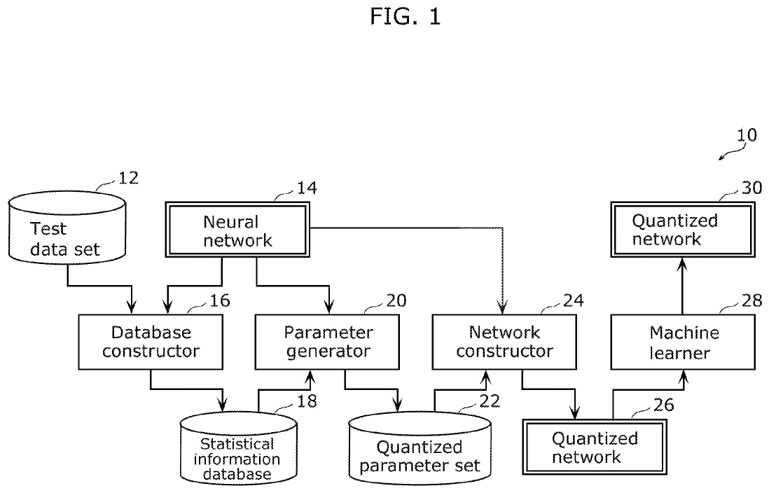

First, a configuration of the network quantization device according to the present embodiment will be described with reference to FIG. 1. FIG. 1 is a block diagram illustrating an overview of a functional configuration of network quantization device 10 according to the present embodiment.

Network quantization device 10 is a device that quantizes neural network 14. That is, network quantization device 10 is a device that transforms neural network 14 having floating-point accuracy into a quantized network that is a neural network having fixed-point accuracy. Note that network quantization device 10 does not necessarily have to quantize all tensors handled by neural network 14, and may quantize at least some of the tensors. The term tensor as used herein refers to values expressed as an n-dimensional array that includes parameters such as input data, output data, and a weight in each of a plurality of layers that make up neural network 14, where n is an integer greater than or equal to 0. Here, the layers of neural network 14 include an input layer via which signals are input to neural network 14, an output layer via which signals are output from neural network 14, and hidden layers via which signals are transmitted between the input layer and the output layer.

The tensor may also include parameters regarding a smallest unit of operations in neural network 14. In the case where neural network 14 is a convolutional neural network, the tensor may include a weight and a bias value that are functions defined as a convolutional layer. The tensor may also include parameters for processing such as normalization processing performed in neural network 14.

As illustrated in FIG. 1, network quantization device 10 includes database constructor 16, parameter generator 20, and network constructor 24. In the present embodiment, network quantization device 10 further includes machine learner 28.

Database constructor 16 is a processing unit that constructs statistical information database 18 on tensors that are handled by neural network 14, the tensors being obtained by inputting a plurality of test data sets 12 to neural network 14. Database constructor 16 calculates, for example, a redundancy of each tensor handled by neural network 14 with reference to test data sets 12 and constructs statistical information database 18 on each tensor. Statistical information database 18 includes redundancies of tensors included in each of the layers of neural network 14. For example, database constructor 16 may determine the redundancy of each tensor in accordance with the result of tensor decomposition. The redundancies of the tensors will be described later in detail. Statistical information database 18 may also include, for example, at least some statistics for each tensor, such as an average value, a median value, a mode value, a greatest value, a smallest value, a maximum value, a minimum value, dispersion, deviation, skewness, and kurtosis.

Parameter generator 20 is a processing unit that generates quantized parameter sets by quantizing the values of tensors in accordance with statistical information database 18 and neural network 14. Parameter generator 20 determines the quantization type for each of the layers of neural network 14. The quantization type may be selected from among, for example, a plurality of numerical transformation types each performing different numerical transformations on tensors. The numerical transformation types may include, for example, logarithmic transformation and non-transformation. The quantization type may also be selected from among a plurality of fineness types each having different degrees of fineness of quantization. The fineness types may include, for example, an N-bit fixed-point type and a ternary type, where N is an integer greater than or equal to 2. Parameter generator 20 determines the quantization type in accordance with the redundancies of tensors included in each of the layers of neural network 14. Parameter generator 20 quantizes the values of the tensors, using the determined quantization type. Detailed processing contents of parameter generator 20 will be described later.

Network constructor 24 is a processing unit that constructs quantized network 26 by quantizing neural network 14 with use of quantized parameter sets 22.

Machine learner 28 is a processing unit that subjects quantized network 26 to machine learning. Machine learner 28 subjects quantized network 26 constructed by network constructor 24 to machine learning by inputting test data sets 12 or other input data sets to quantized network 26. Accordingly, machine learner 28 constructs quantized network 30 having excellent inference accuracy from quantized network 26. Note that network quantization device 10 does not necessarily have to include machine learner 28.

With the configuration as described above, network quantization device 10 is capable of constructing a quantized network having excellent accuracy.

### 1-2. Hardware Configuration

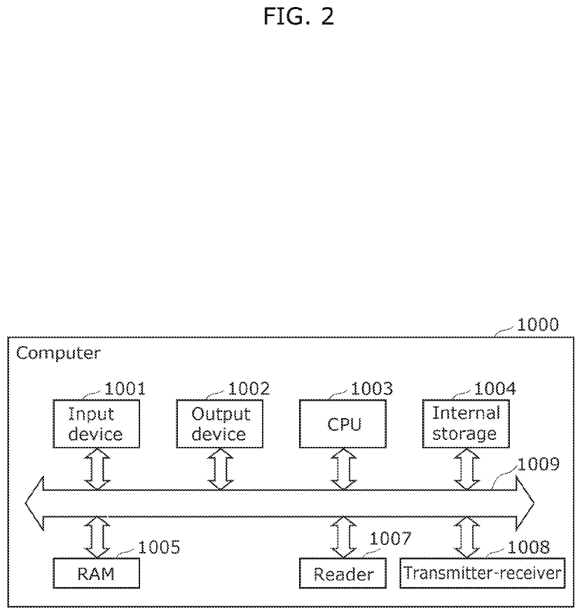

Next, a hardware configuration of network quantization device 10 according to the present embodiment will be described with reference to FIG. 2. FIG. 2 is a diagram showing one example of the hardware configuration of computer 1000 that implements, via software, the functions of network quantization device 10 according to the present embodiment.

As illustrated in FIG. 2, computer 1000 includes input device 1001, output device 1002, CPU 1003, built-in storage 1004, RAM 1005, reader 1007, transmitter-receiver 1008, and bus 1009. Input device 1001, output device 1002, CPU 1003, built-in storage 1004, RAM 1005, reader 1007, and transmitter-receiver 1008 are connected via bus 1009.

Input device 1001 is a device that serves as a user interface such as an input button, a touch pad, or a touch panel display and accepts user operations. Note that input device 1001 may also be configured to accept voice operations or remote operations via a remote controller or any other device, in addition to accepting touch operations from users.

Output device 1002 is a device that outputs signals from computer 1000, and may also be a device that serves as a user interface such as a display or a speaker, in addition to serving as a signal output terminal.

Built-in storage 1004 may, for example, be a flash memory. Built-in storage 1004 may also store, in advance, at least one of a program for realizing the functions of network quantization device 10 and an application using the functional configuration of network quantization device 10.

RAM 1005 is a random access memory that is used to store data and so on during execution of a program or an application.

Reader 1007 retrieves information from a recording medium such as a universal serial bus (USB) memory. Reader 1007 retrieves a program or an application as described above from the recording medium on which the program or the application is stored, and stores the retrieved program or application in built-In storage 1004.

Transmitter-receiver 1008 is a communication circuit for wireless or wired communication. Transmitter-receiver 1008 may communicate with, for example, a server device connected to the network, download a program or an application as described above from the server device, and store the downloaded program or application in built-in storage 1004.

CPU 1003 is a central processing unit that copies, for example, a program or an application stored in built-in storage 1004 into RAM 1005 and sequentially retrieves and executes commands included in the program or the application from RAM 1005.

### 1-3. Network Quantization Method

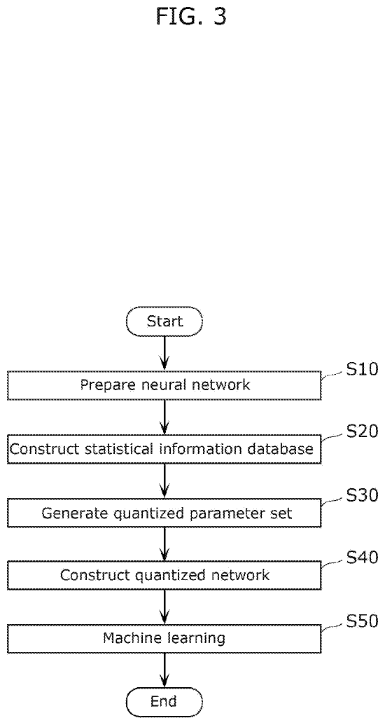

Next, the network quantization method according to the present embodiment will be described with reference to FIG. 3. FIG. 3 is a flowchart illustrating a procedure of the network quantization method according to the present embodiment.

As illustrated in FIG. 3, the network quantization method first involves preparing neural network 14 (S10). In the present embodiment, neural network 14 that is trained in advance is prepared. Neural network 14 is a network that is not quantized, i.e., a neural network having floating-point accuracy. There are no particular limitations on input data that is used for training of neural network 14, and the input data may include test data sets 12 illustrated in FIG. 1.

Then, database constructor 16 constructs statistical information database on tensors that are handled by neural network 14, the tensors being obtained by inputting test data sets 12 to neural network 14 (S20). In the present embodiment, database constructor 16 calculates redundancies of tensors included in each of the layers of neural network 14 and constructs statistical information database 18 that includes the redundancy of each tensor. In the present embodiment, the redundancy of each tensor is determined based on the result of tensor decomposition of the tensor. The method of calculating redundancies will be described later.

Then, parameter generator 20 generates quantized parameter sets 22 by quantizing the values of the tensors in accordance with statistical information database 18 and neural network 14 (S30). Parameter generation step S30 includes a quantization-type determination step of determining the quantization type for each of the layers of neural network 14. The quantization-type determination step will be described later in detail.

Then, network constructor 24 constructs quantized network 26 by quantizing neural network 14 with use of quantized parameter sets 22 (S40).

Then, machine learner 28 subjects quantized network 26 to machine learning (S50). Machine learner 28 subjects quantized network 26 constructed by network constructor 24 to machine learning by inputting test data sets 12 or other input data sets to quantized network 26. Accordingly, quantized network 30 having excellent inference accuracy is constructed from quantized network 26. Note that the network quantization method according to the present embodiment does not necessarily have to include machine learning step S50.

As described above, the network quantization method according to the present embodiment allows accurate quantization of the neural network.

### 1-4. Redundancy

Next, the redundancies of the tensors calculated by database constructor 16 will be described. The redundancy of each tensor refers to a measure that corresponds to the ratio of information content of the tensor that can be reduced while constraining a reduction in the inference accuracy of neural network 14 to fall within a predetermined range. In the present embodiment, the redundancy of a tensor refers to a measure obtained by focusing attention on the semantic structure (i.e., principal component) of the tensor, and can be expressed as the ratio of information content of components that can be cut down by constraining a reconstruction error correlated with the inference accuracy of neural network 14 to fall within a predetermined range (i.e., components deviated from the principal component) to the original information content of the tensor.

One example of the method of calculating the redundancy of each tensor will be described below.

A J-dimensional tensor (multidimensional array with J dimensions; J is an integer greater than or equal to 2) can be decomposed into a K-dimensional core tensor and J factor matrices by a mathematical technique, where K is an integer smaller than J and greater than or equal to 1. Specifically, this tensor decomposition corresponds to solving an optimization problem of approximating the J-dimensional tensor to the K-dimensional tensor. This means that, if noise components are ignored to some degree, the J-dimensional tensor can be generally approximated to the K-dimensional tensor and the factor matrices. That is, complexity of such a degree that each component of the K-dimensional tensor can be expressed is enough to express the original J-dimensional tensor. A resultant value (J-K)/J obtained by the tensor decomposition described above is defined as the redundancy. Note that the fineness of the term redundancy is not limited to this example. For example, K/J may be defined as the redundancy.

One example of the tensor decomposition method will be described here. The tensor decomposition may, for example, be CP decomposition or Tucker decomposition. For example, J-dimensional tensor W may be approximated to a product of K-dimensional core tensor U and factor matrices V through CP decomposition as expressed by Expression (1) below.

W≅UV Expression 1

In this case, reconstruction error RecErr that is correlated with the inference accuracy of neural network 14 can be expressed by the value obtained by normalizing a difference between the L2 norm of the original tensor and the L2 norm of a restored tensor obtained by restoring the core tensor to the shape of the original tensor by the L2 norm of the original tensor. That is, reconstruction error RecErr is obtained from Expression (2) below.

$$RecErr = \frac{\sqrt{\vert {{‖ W ‖}_{2}}^{2} - {{‖ U \cdot V ‖}_{2}}^{2} \vert}}{{‖ W ‖}_{2}} \qquad Expression 2$$

Accordingly, redundancy (K/J) can be obtained by the tensor decomposition while constraining reconstruction error RecErr to fall within a predetermined range.

Similarly, in the case where the tensor decomposition is Tucker decomposition, reconstruction error RecErr can be obtained from Expression (3) below in accordance with original tensor W and core tensor C.

$$RecErr = \frac{\sqrt{\vert {{‖ W ‖}_{2}}^{2} - {{‖ C ‖}_{2}}^{2} \vert}}{{‖ W ‖}_{2}} \qquad Expression 3$$

The redundancies of the tensors included in each of the layers of neural network 14 can be obtained as described above.

### 1-5. Parameter Generator

Next, the method of generating quantized parameter sets 22 by parameter generator 20 according to the present embodiment will be described in detail.

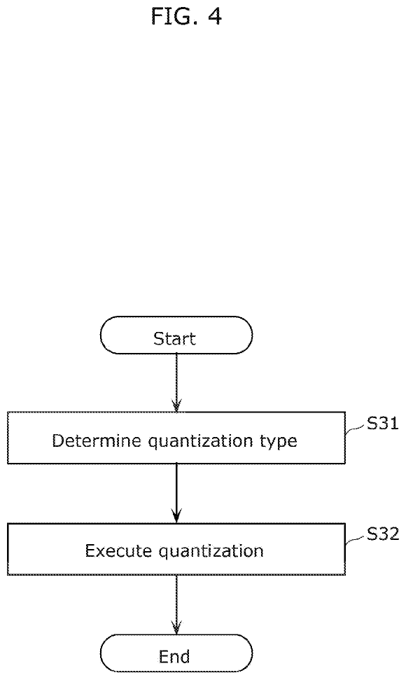

As described above, parameter generator 20 generates quantized parameter sets by quantizing the values of tensors in accordance with statistical information database 18 and neural network 14. Hereinafter, the method of generating quantized parameter sets by parameter generator 20 will be described with reference to FIG. 4. FIG. 4 is a flowchart illustrating a procedure of the method of generating quantized parameter sets according to the present embodiment.

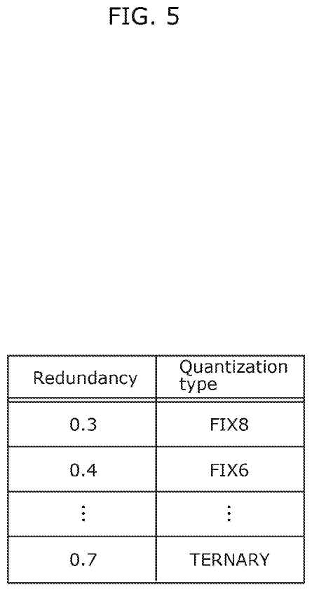

As illustrated in FIG. 4, the method of generating quantized parameter sets according to the present embodiment first involves preparing the quantization type for each tensor included in each of the layers of neural network 14 (S31). In the present embodiment, the quantization type is determined based on the redundancy included in statistical information database 18. In the present embodiment, before the generation of the quantized parameter sets, the relationship between redundancies and suitable quantization types is obtained using other neural networks as sample models. This relationship between redundancies and suitable quantization types will be described with reference to FIG. 5. FIG. 5 is an illustration of a table showing one example of the relationship between redundancies and suitable quantization types according to the present embodiment. In the example illustrated in FIG. 5, when the redundancy of a tensor is 0.3, the quantization type of the tensor is determined as an 8-bit fixed point type (FIX8). When the redundancy of a tensor is 0.4, the quantization type of the tensor is determined as a 6-bit fixed point type (FIX6). When the redundancy of a tensor is 0.7, the quantization type of the tensor is determined as a ternary type (TERNARY). In this way, in quantization-type determination step S31, a quantization type with lower fineness may be selected as the redundancy of the tensor increases. This enables selecting a quantization type with low fineness while suppressing a reduction in the inference accuracy of quantized network 26. Selecting a quantization type with low fineness in this way keeps down the cost of hardware that implements the quantized network. This technique of obtaining the relationship between redundancies and suitable quantization types in advance with use of other neural networks as sample models is in particular effective when neural network 14 to be quantized is similar in type to the other neural networks used as sample models. For example, in the case where neural network 14 is a neural network for object detection, the quantization type suitable for neural network 14 can be selected by using other neural networks for object detection as sample models.

In quantization-type determination step S31, each numerical value included in the tensor may be transformed nonlinearly. The numerical transformation type for the tensor as the quantization type may be selected from among a plurality of numerical transformation types that include logarithmic transformation and non-transformation. For example, in the case where the frequency of the values included in the tensor is particularly high in the vicinity of zero, all elements of the tensor may be subjected to logarithmic transformation. That is, all elements of the tensor may be transformed into logarithms of the numerical values. Accordingly, it is possible to increase the redundancy of the tensor when the frequency of all elements of the tensor is high in the range that is close to zero.

In quantization-type determination step S31, the fineness of quantization for a quantization type may be selected from among a plurality of fineness types that include an N-bit fixed point type and a ternary type.

Then, the tensors included in each of the layers of neural network 14 are quantized (S32). Specifically, for example, in the case where quantization with N-bit fixed-point accuracy is used as the quantization type, the values included in each tensor are quantized with N-bit fixed-point accuracy.

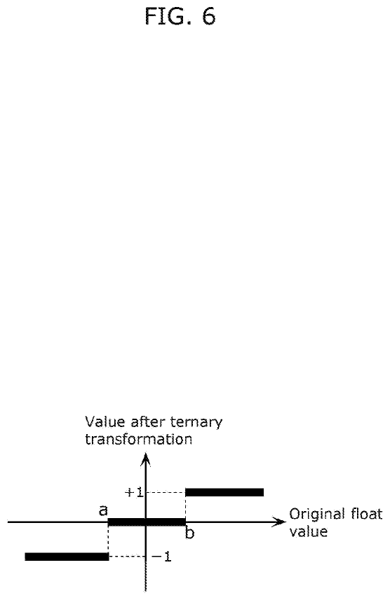

Moreover, as another example of the quantization type, a case of using the ternary type will be described with reference to FIG. 6. FIG. 6 is a graph for describing ternary transformation of numerical values with floating-point accuracy. In the graph illustrated in FIG. 6, the horizontal axis indicates the numerical value with floating-point accuracy that is to be quantized (“original Float value” illustrated in FIG. 6), and the vertical axis indicates the value after the ternary transformation.

As illustrated in FIG. 6, in the case where the ternary transformation is used as the quantization type, among the numerical values with floating-point accuracy, those that are less than or equal to predetermined first value a are quantized to −1, those that are greater than first value a and less than or equal to predetermined second value b are quantized to 0, and those that are greater than second value b are quantized to +1. In this way, in the case where the ternary transformation is used as the quantization type, multiplications in computations such as convolutional computations in the quantized network can be replaced by XOR operations. This reduces the resources of the hardware that implements the quantized network.

As described above, the quantized parameter sets can be generated by quantization of the tensors.

### 1-6. Advantageous Effects

As described above, the network quantization method according to the present embodiment is a network quantization method of quantizing neural network 14, and includes a preparatory step, a database construction step, a parameter generation step, and a network construction step. The preparatory step is preparing neural network 14. The database construction step is constructing statistical information database 18 on tensors that are handled by neural network 14, the tensors being obtained by inputting test data sets 12 to the neural network. The parameter generation step is generating quantized parameter sets 22 by quantizing the values of the tensors in accordance with statistical Information database 18 and neural network 14. The network construction step is constructing quantized network 26 by quantizing neural network 14, using quantized parameter sets 22. The parameter generation step includes a quantization-type determination step of determining the quantization type for each of the layers of the neural network.

In this way, selecting the quantization type for each of the layers of neural network 14 makes the efficient bit assignment possible depending on the characteristics of each layer. Accordingly, it is possible to construct a quantized network in which bits are assigned efficiently.

In the quantization-type determination step of the network quantization method according to the present embodiment, the quantization type may be selected from among a plurality of numerical transformation types each performing different numerical transformations on the tensor, and the numerical transformation types may include logarithmic transformation and non-transformation.

This enables selecting the numerical transformation method for tensors in accordance with, for example, the distribution of numerical values included in the tensor. For example, more efficient bit assignment is made possible by performing such numerical transformation that increases the redundancy of the tensor. Accordingly, it is possible to construct a quantized network in which bits are assigned yet more efficiently.

In the quantization-type determination step of the network quantization method according to the present embodiment, the quantization type may be selected from among a plurality of fineness types each having different degrees of fineness of quantization, and the fineness types may include an N-bit fixed point type and a ternary type.

This allows the fineness of quantization to be selected in accordance with, for example, the redundancy of the tensor. Accordingly, it is possible to perform quantization for each layer so as to suppress a reduction in the inference accuracy of the quantized network.

In the network quantization method according to the present embodiment, the quantization type may be determined based on the redundancies of tensors included in each of the layers.

In general, as the redundancies of the tensors increase, quantization with lower fineness can be adopted while suppressing a reduction in inference accuracy. Thus, determining the quantization type based on the redundancies makes it possible to adopt quantization with low fineness while suppressing a reduction in inference accuracy. Lowering the fineness of quantization in this way reduces the cost of hardware that implements the quantized network.

In the network quantization method according to the present embodiment, the redundancy of each tensor may be determined based on the result of tensor decomposition of the tensor.

In the network quantization method according to the present embodiment, the quantization type may be determined such that a quantization type with lower fineness is selected as the redundancy of the tensor increases.

Accordingly, it is possible to adopt quantization with low fineness while suppressing a reduction in inference accuracy.

The network quantization device according to the present embodiment is network quantization device 10 for quantizing neural network 14, and includes database constructor 16, parameter generator 20, and network constructor 24. Database constructor 16 constructs statistical information database 18 on tensors that are handled by neural network 14, the tensors being obtained by inputting test data sets 12 to neural network 14. Parameter generator 20 generates quantized parameter sets 22 by quantizing the values of the tensors in accordance with statistical information database 18 and neural network 14. Network constructor 24 constructs quantized network 26 by quantizing neural network 14, using quantized parameter sets 22. Parameter generator 20 determines the quantization type for each of the layers of neural network 14.

Accordingly, it is possible to achieve similar effects to those achieved by the network quantization method according to the present embodiment.

### Embodiment 2

A network quantization method and so on according to Embodiment 2 will be described. The network quantization method according to the present embodiment differs in the quantization-type determination method from the quantization method according to Embodiment 1. The following description focuses on the points of difference of the network quantization method and the network quantization device according to the present embodiment from those of Embodiment 1.

### 2-1. Network Quantization Apparatus

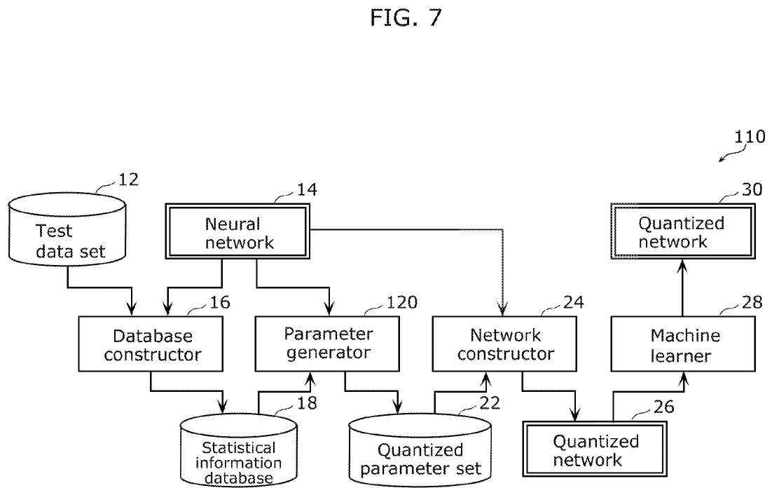

First, a configuration of the network quantization device according to the present embodiment will be described with reference to FIG. 7. FIG. 7 is a block diagram illustrating an overview of a functional configuration of network quantization device 110 according to the present embodiment.

As illustrated in FIG. 7, network quantization device 110 includes database constructor 16, parameter generator 120, and network constructor 24. In the present embodiment, network quantization device 110 further includes machine learner 28. Network quantization device 110 according to the present embodiment differs in parameter generator 120 from network quantization device 10 according to Embodiment 1.

Like parameter generator 20 according to Embodiment 1, parameter generator 120 according to the present embodiment generates quantized parameter sets 22 by quantizing the values of tensors in accordance with statistical information database 18 and neural network 14. Parameter generator 120 also determines the quantization type for each of a plurality of layers that make up neural network 14. Parameter generator 120 according to the present embodiment determines the quantization type in accordance with the redundancies of the tensors included in the layers of neural network 14 and the redundancies of the tensors after quantization. Specifically, the quantization type is determined in accordance with the redundancies of the tensors included in statistical information database 18 and the redundancies of quantized tensors obtained by quantizing the tensors included in statistical Information database 18. The redundancies of the quantized tensors may be calculated by, for example, parameter generator 120.

### 2-2. Network Quantization Method

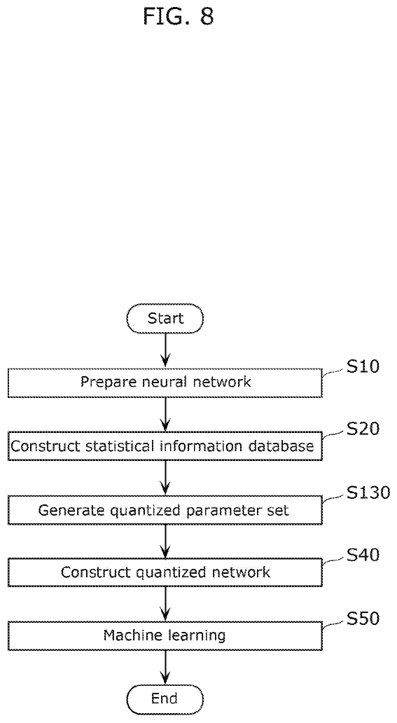

Next, the network quantization method according to the present embodiment and an inference method using this network quantization method will be described with reference to FIG. 8. FIG. 8 is a flowchart illustrating a procedure of the network quantization method according to the present embodiment.

As illustrated in FIG. 8, like the network quantization method according to Embodiment 1, the network quantization method according to the present embodiment includes preparatory step S10 of preparing neural network 14, database construction step S20 of constructing statistical information database 18, parameter generation step S130 of generating quantized parameter sets 22, network construction step S40 of constructing a quantized network, and machine learning step S50 of subjecting quantized network 26 to machine learning.

The network quantization method according to the present embodiment differs in parameter generation step S130 from the network quantization method according to Embodiment 1.

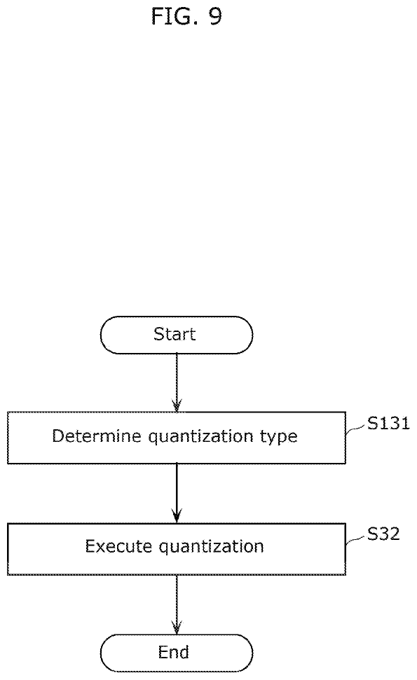

Parameter generation step S130 according to the present embodiment will be described with reference to FIG. 9. FIG. 9 is a flowchart illustrating a procedure of parameter generation step S130 according to the present embodiment. Like parameter generation step S30 according to Embodiment 1, parameter generation step S130 according to the present embodiment includes quantization-type determination step S131 and quantization execution step S32. Parameter generation step S130 according to the present embodiment differs in quantization-type determination step S131 from parameter generation step S30 according to Embodiment 1.

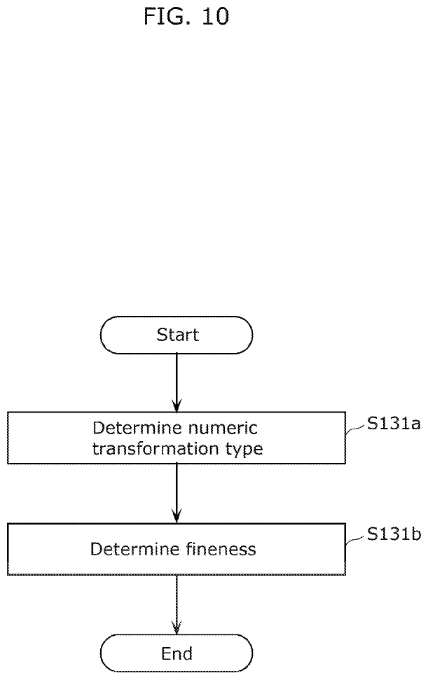

Quantization-type determination step S131 according to the present embodiment will be described with reference to FIG. 10. FIG. 10 is a flowchart illustrating a procedure of quantization-type determination step S131 according to the present embodiment.

As illustrated in FIG. 10, quantization-type determination step S131 according to the present embodiment first involves determining the numerical transformation type used for the tensor as the quantization type (S131a). For example, the numerical transformation type for the tensor as the quantization type may be selected from among a plurality of numerical transformation types that include logarithmic transformation. In the present embodiment, the numerical transformation type is selected from among (a) logarithmic transformation, (b) pseudo ternary transformation, and (c) uniform quantization (non-transformation).

The points of attention to determine the numerical transformation type are the following features on the distribution of elements related to the principal component of the tensor.

(a) When the distribution of elements related to the principal component is concentrated on values around zero, logarithm quantization is advantageous in which the quantization step performed on values around zero becomes dense.

(b) When the distribution of elements related to the principal component does not exist around zero, quantization that eliminates information on values around zero, i.e., sets the values to zero, is advantageous. One example is pseudo ternary transformation.

(c) When the distribution of elements related to the principal component applies to neither (a) nor (b) described above, uniform quantization is advantageous.

The calculation of the aforementioned distribution of elements may be implemented by, for example, a method of repeatedly performing histogram calculations that require computational complexity. In order to reduce computational complexity, the present embodiment adopts a method of performing the numerical transformations performed in the cases of (a) and (b) to obtain redundancies by way of example of the method of simply determining the numerical transformation type, using the aforementioned point of attention.

The method of selecting the numerical transformation type according to the present embodiment will be described. Parameter generator 120 determines redundancy R of a tensor concerned, for which the quantization type is to be determined, redundancy R_{L} of a tensor obtained by performing logarithm arithmetic on all elements of the tensor concerned, and redundancy R_{PT} of a pseudo ternary-transformed tensor obtained by performing pseudo ternary transformation on all elements of the tensor concerned. Redundancy R is acquired from statistical information database 18, and redundancy R_{L} is calculated by parameter generator 120.

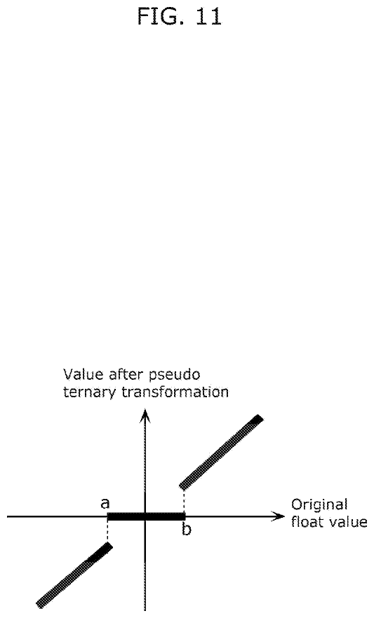

The pseudo ternary transformation will be described with reference to FIG. 11. FIG. 11 is a graph for describing the pseudo ternary transformation of numerical values with floating-point accuracy. In the graph illustrated in FIG. 11, the horizontal axis indicates the numerical value with floating-point accuracy that is to be quantized (“original Float value” illustrated in FIG. 11), and the vertical axis indicates the value after the pseudo ternary transformation.

As illustrated in FIG. 11, when the pseudo ternary transformation is performed on the numerical values with floating-point accuracy, those of the numerical values with floating-point accuracy that are greater than or equal to predetermined first value a and those that are greater than predetermined second value b are maintained as-is, and those that are greater than first value a and those that are less than or equal to second value b are transformed to zero.

Next, comparison is made among redundancy R of the tensor concerned, for which the quantization type is to be determined, redundancy R_{L} of the tensor obtained by performing logarithm arithmetic on all elements of the tensor concerned, and redundancy R_{PT} of the tensor obtained by performing pseudo ternary transformation on all elements of the tensor concerned. Here, when R_{L}>R, this means that the redundancy increases more when logarithm arithmetic is performed on all elements of the tensor concerned, i.e., a reduction in inference accuracy can be suppressed even if quantization is performed with lower fineness. Accordingly, when R_{L}>R, the numerical transformation type is determined as logarithmic transformation. On the other hand, when R_{L}≤R, it is determined that the execution of logarithm arithmetic on all elements of the tensor concerned has no advantageous effects.

Meanwhile, when R_{PT}>R, this means that the redundancy of the tensor increases more when pseudo ternary arithmetic is performed on all elements of the tensor concerned, i.e., a reduction in inference accuracy can be suppressed even if quantization is performed with lower fineness. Accordingly, when R_{PT}>R, the numerical transformation type is determined as pseudo ternary transformation. On the other hand, when R_{PT}≤R, it is determined that the execution of pseudo ternary arithmetic on all elements of the tensor concerned has no advantageous effects. Note that the distribution of elements related to the principal component around zero where each of logarithmic transformation and pseudo ternary transformation are assumed to be advantageous has mutually contradictory features. Thus, when both R_{L}>R and R_{PT}>R are satisfied, a contradiction to the assumption arises and therefore it is determined that the execution of logarithmic transformation and pseudo ternary transformation have no advantageous effects. If there are determined no advantageous effects on the basis of the aforementioned results of determining the effects of the logarithmic transformation and the pseudo ternary arithmetic, the numerical transformation type is determined as non-transformation.

Then, the fineness of quantization using the quantization type is determined (S131b). In the present embodiment, the fineness of quantization is selected from among a plurality of fineness types that include an N-bit fixed point type and a ternary type. In the case where fixed-point accuracy is adopted from among the fineness types of quantization, the number of bits with fixed-point accuracy is determined as a maximum number of implementable bits in accordance with the configuration of the hardware that implements the quantized network. The following gives a description of a method of determining which of the fixed point type and the ternary type is to be selected from among the fineness types of quantization.

In the case where the ternary type is selected as the fineness of quantization, 2-bit fixed-point accuracy and 3-bit fixed-point accuracy may become targets for comparison as the degrees of fineness close to the ternary type, because the numerical values can be expressed by two bits. Thus, redundancies are calculated when 2-bit fixed-point accuracy is selected as the fineness of quantization and when 3-bit fixed-point accuracy is selected as the fineness of quantization. Redundancy R_{N2} of a 2-bit tensor and redundancy R_{N3} of a 3-bit tensor are calculated, the redundancy of the 2-bit tensor being obtained by setting the accuracy of all elements of the tensor concerned to 2-bit fixed-point accuracy, and the redundancy of the 3-bit tensor being obtained by setting the accuracy of all elements of the tensor concerned to 3-bit fixed-point accuracy. Then, when the numerical transformation type is the pseudo ternary type and R_{N2}<R_{N3} is satisfied, it is determined that the ternary type is not suitable as the fineness of quantization of the tensor, and 3-bit or more-bit fixed-point accuracy is selected as the fineness of quantization in accordance with the hardware configuration.

On the other hand, when R_{N2}≥R_{N3} is satisfied and when the numerical transformation type is the pseudo ternary type, the ternary type is selected as the fineness of quantization of the tensor. When R_{N2}≥R_{N3} is satisfied and when the numerical transformation type is either logarithmic transformation or non-transformation, 2-bit fixed-point accuracy is selected as the fineness of quantization of the tensor.

As described above, it is possible to determine the type and fineness of quantization suitable for each tensor.

### Variations

Although the network quantization method and so on according to the present disclosure have been described based on each embodiment, the present disclosure is not intended to be limited to these embodiments. Other embodiments, such as those obtained by making various modifications that are conceived by those skilled in the art to the embodiments or variations described above and those obtained by combining some constituent elements of each embodiment, are all within the scope of the present disclosure, unless departing from the principles and split of the present disclosure.

For example, although each functional part of the network quantization device according to each embodiment described above shares the function of the network quantization device, the mode of sharing the functions is not limited to the example described above in each embodiment. For example, a plurality of functional parts according to each embodiment described above may be integrated with each other. Although, in Embodiment 2, parameter generator 120 calculates the redundancy of each tensor after quantization, the redundancy of each tensor after quantization may be calculated by database constructor 16 as in the case of calculating the redundancy of each tensor before quantization. In this case, the redundancy of each tensor after quantization may be included in statistical information database 18. Moreover, the redundancies of each tensor before and after quantization may be calculated by a constituent element other than database constructor 16 of the network quantization device. Moreover, the redundancies of each tensor before and after quantization may be calculated in a step other than the database construction step.

Although, in Embodiment 2 described above, the fineness of quantization is selected from among a plurality of fineness types including the ternary type, these fineness types do not necessarily have to include the ternary type.

Embodiments described below may also be included within the scope of one or a plurality of aspects of the present disclosure.

(1) Some of the constituent elements of the network quantization device described above may be a computer system that includes, for example, a microprocessor, a ROM, a RAM, a hard disk unit, a display unit, a keyboard, and a mouse. The RAM or the hard disk unit stores computer programs. The microprocessor achieves its functions by operating in accordance with the computer programs. The computer programs as used herein refer to those configured by combining a plurality of instruction codes that indicate commands given to the computer in order to achieve predetermined functions.

(2) Some of the constituent elements of the network quantization device described above may be made up of a single-system large scale integrated (LSI) circuit. The system LSI circuit is a ultra-multifunction LSI circuit manufactured by Integrating a plurality of components on a single chip, and is specifically a computer system that includes, for example, a microprocessor, a ROM, and a RAM. The RAM stores computer programs. The system LSI circuit achieves its functions by causing the microprocessor operating to operate in accordance with the computer programs.

(3) Some of the constituent elements of the network quantization device described above may be configured as an IC card or a united module that is detachable from each device. The IC card or the module is a computer system that includes, for example, a microprocessor, a ROM, and a RAM. The IC card or the module may also be configured to include the ultra-multifunction LSI circuit described above. The IC card or the module achieves its functions by causing the microprocessor to operate in accordance with the computer programs. The IC card or the module may have protection against tampering.

(4) Some of the constituent elements of the network quantization device described above may be implemented as a computer-readable recording medium that records the computer programs or the digital signals described above, e.g., may be implemented by recording the computer programs or the digital signals described above on a recording medium such as a flexible disk, a hard disk, a CD-ROM, an MO, a DVD, a DVD-ROM, a DVD-RAM, a Blu-ray disc (BD: registered trademark), or a semiconductor memory. These constituent elements may also be implemented as the digital signals recorded on the recording medium as described above.

Some of the constituent elements of the network quantization device described above may be configured to transmit the computer programs or the digital signals described above via, for example, telecommunication lines, wireless or wired communication lines, a network represented by the Internet, or data broadcasting.

(5) The present disclosure may be implemented as the methods described above. The present disclosure may also be implemented as a computer program for causing a computer to execute the methods described above, or may be implemented as digital signals of the computer programs. The present disclosure may also be implemented as a non-transitory computer-readable recording medium such as a CD-ROM that records the above computer programs.

(6) The present disclosure may also be implemented as a computer system that includes a microprocessor and a memory, in which the memory may store the computer programs described above and the microprocessor may operate in accordance with the computer programs described above.

(7) The present disclosure may also be implemented as another independent computer system by transferring the above-described programs or digital signals that are recorded on the recording medium described above, or by transferring the above-described programs or digital signals via a network or the like.

(8) The embodiments and variations described above may be combined with one another.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is applicable to, for example, an image processing method as a method of implementing a neural network in a computer.

1. A network quantization method of quantizing a neural network, the network quantization method comprising:
preparing the neural network;
constructing a statistical information database on a tensor that is handled by the neural network, the tensor being obtained by inputting a plurality of test data sets to the neural network;
generating a quantized parameter set by quantizing a value included in the tensor in accordance with the statistical information database and the neural network; and
constructing a quantized network by quantizing the neural network with use of the quantized parameter set,
wherein the generating includes determining a quantization type for each of a plurality of layers that make up the neural network.

2. The network quantization method according to claim 1,
wherein the determining includes selecting the quantization type from among a plurality of numerical transformation types each performing different numerical transformations on the tensor, and the plurality of numerical transformation types include logarithmic transformation and non-transformation.

3. The network quantization method according to claim 1,
wherein the determining Includes selecting the quantization type from among a plurality of fineness types each having different degrees of fineness of quantization, and
the plurality of fineness types include an N-bit fixed-point type and a ternary type, where N is an integer greater than or equal to 2.

4. The network quantization method according to claim 2,
wherein the determining includes selecting the quantization type from among a plurality of fineness types each having different degrees of fineness of quantization, and
the plurality of fineness types include an N-bit fixed-point type and a ternary type, where N is an integer greater than or equal to 2.

5. The network quantization method according to claim 1,
wherein the quantization type is determined based on a redundancy of the tensor included in each of the plurality of layers.

6. The network quantization method according to claim 5,
wherein the redundancy is determined based on a result of tensor decomposition of the tensor.

7. The network quantization method according to claim 5,
wherein the quantization type is determined as a type with lower fineness as the redundancy increases.

8. The network quantization method according to claim 6,
wherein the quantization type is determined as a type with lower fineness as the redundancy increases.

9. A network quantization device for quantizing a neural network, the network quantization device comprising:
a database constructor that constructs a statistical information database on a tensor that is handled by the neural network, the tensor being obtained by inputting a plurality of test data sets to the neural network;
a parameter generator that generates a quantized parameter set by quantizing a value included in the tensor in accordance with the statistical information database and the neural network; and
a network constructor that constructs a quantized network by quantizing the neural network with use of the quantized parameter set,
wherein the parameter generator determines a quantization type for each of a plurality of layers that make up the neural network.
